(19) United States
(12) Patent Application Publication
(10) Pub. No.: US 2025/0008313 A1
(43) Pub. Date: Jan. 2, 2025

(54) SYSTEM AND METHOD FOR NETWORK DRIVEN SLICE SWITCHING

(71) Applicant: VERIZON PATENT AND LICENSING INC., Basking Ridge, NJ (US)

(72) Inventors: Deepak MAJJIGA, Irving, TX (US); Kristen Sydney YOUNG, Mine Hill, NJ (US)

(73) Assignee: VERIZON PATENT AND LICENSING INC., Basking Ridge, NJ (US)

(21) Appl. No.: 18/341,951

(22) Filed: Jun. 27, 2023

(51) Int. Cl. H04W 8/18; H04W 76/10

(52) U.S. Cl. CPC H04W 8/18; H04W 76/10

(57) ABSTRACT

Disclosed are systems and methods for a network slice profile management within 5G network infrastructures and operating environments. The disclosed systems and methods can provide mechanisms for automatically selecting slice profiles for specific applications, user profiles and/or experience modes. The disclosed systems and methods involve the novel implementation of specifically designated slice profiles within an universal software radio peripheral (USRP), from which network traffic from a device can be designated via selected slice profiles from the USRP based on types of user profiles being leveraged for application sessions from the user's device.

### BACKGROUND INFORMATION

Network slicing in fifth generation (5G) networks refers to a network configuration that allows multiple networks to be implemented within a common 5G network architecture.

### BRIEF DESCRIPTION OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example network architecture according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIGS. 4A-4B illustrate non-limiting example embodiments of the present disclosure; and

FIG. 5 is a block diagram illustrating a computing device showing an example of a client or server device used in various embodiments of the present disclosure.

### DETAILED DESCRIPTION OF EXAMPLE EMBODIMENTS

A network slice refers to a logically shared or isolated, end-to-end portion of a 5G network that is dedicated to providing specific services or functionalities. For example, a network slice allows network operators to create multiple virtual networks on a shared physical infrastructure, tailoring each slice to meet the unique requirements of different applications, industries, or customers.

A network slice includes various network resources, including radio access network (RAN) resources, core network resources, and transport network resources. These resources are allocated and optimized to deliver the desired quality of service (QOS) and performance characteristics for the specific use case associated with the slice.

Network slicing enables the efficient utilization of network infrastructure by dynamically allocating resources based on demand, traffic patterns, and service requirements. Network slicing allows the network to be flexible and adaptable, supporting diverse use cases with varying latency, bandwidth, security, and reliability needs.

By way of a non-limiting example, a network operator can create different slices for enhanced mobile broadband (eMBB) services, massive machine-type communications (mMTC), and ultra-reliable low-latency communications (URLLC). In another non-limiting example, different slices can be created for variations of slices (e.g., eMBB₁, eMBB₂, and the like), which can be in relation to different customers, experiences and/or requirements of a user, application and/or device, for example. Each slice can be customized to meet the specific needs of applications, such as, for example, high-definition video streaming. Internet of Things (IoT) connectivity, or mission-critical communications.

By leveraging network slicing, 5G networks can provide a more scalable, efficient, reliable and versatile infrastructure, accommodating a wide range of use cases and applications with different service requirements.

Accordingly, as discussed herein, 5G network operating environments can implement network slice profiles. A network slice profile is a predefined template or specification that defines the characteristics, capabilities, and parameters of a network slice. A network slice profile can provide a standardized way of describing the attributes and requirements of a particular slice, allowing network operators and service providers to create and deploy slices with consistent configurations.

According to some embodiments, a network slice profile can include information related to, but not limited to, a service type, QoS, resource allocation, security and isolation, network function virtualization (NFV) and software-defined network (SDN), lifecycle management, and the like.

In some embodiments, service type information can specify a type of service or use case a slice is designed for, such as, as discussed above, eMBB, mMTC, URLLC, and the like, and/or variations of slice categories, as discussed supra. QoS information can correspond to QoS parameters that can define performance metrics and QoS requirements for the slice, including parameters such as latency, throughput, reliability, and availability. Resource allocation information can describe an allocation of network resources, including radio spectrum, computing resources, and bandwidth, to meet demands of an intended service or application. Security and Isolation information can specify security mechanisms, protocols and isolation requirements necessary to protect the slice from unauthorized access or interference. NFV and SDN information can provide requirements that outline a virtual network function (VNF) and software-defined network components needed to implement the slice, along with any specific configurations or interoperability requirements. And, lifecycle management information can define lifecycle phases of the slice, including provisioning, activation, monitoring, scaling, and termination, as well as any associated management and orchestration processes.

Accordingly, a network slice profile can serve as a blueprint for creating and configuring network slices, ensuring consistency and interoperability across different deployments. Network slice profiles can enable network operators to efficiently provision and manage slices based on standardized templates, simplifying the deployment of diverse services and reducing the time-to-market for new applications in 5G networks.

The disclosed systems and methods provide a framework that provides novel mechanisms for identifying and differentiating network traffic originating from multiple user profiles within the same application (and device). For example, an application (e.g., BlueJeans™) operating on a user's device (e.g., smartphone or laptop) can enable a user to engage in video conferencing sessions via their work account and personal account. As discussed herein, the disclosed framework can provide advanced security, priority and performance mechanisms that directly correspond to the type of account the user is leveraging for a video conferencing session. For example, enterprise activity (e.g., from a user's work profile) can be subject to additional network security via an enterprise-type network slice, while personal user profile activity may leverage alternative slice profiling features that correlate to social activities. Additionally, for example, the user's work account can therefore be configured to provide additional capabilities (e.g., latency, throughput, reliability, bandwidth, and the like) in order to support advanced features of the video conferencing associated with the BlueJeans™ application. For example, such features can include, but are not limited to, virtual avatars (for virtual reality and/or augmented reality (VR/AR) experiences), collaboration boards, and the like, which would not be possible prior to the instant disclosure's implementation using personal accounts.

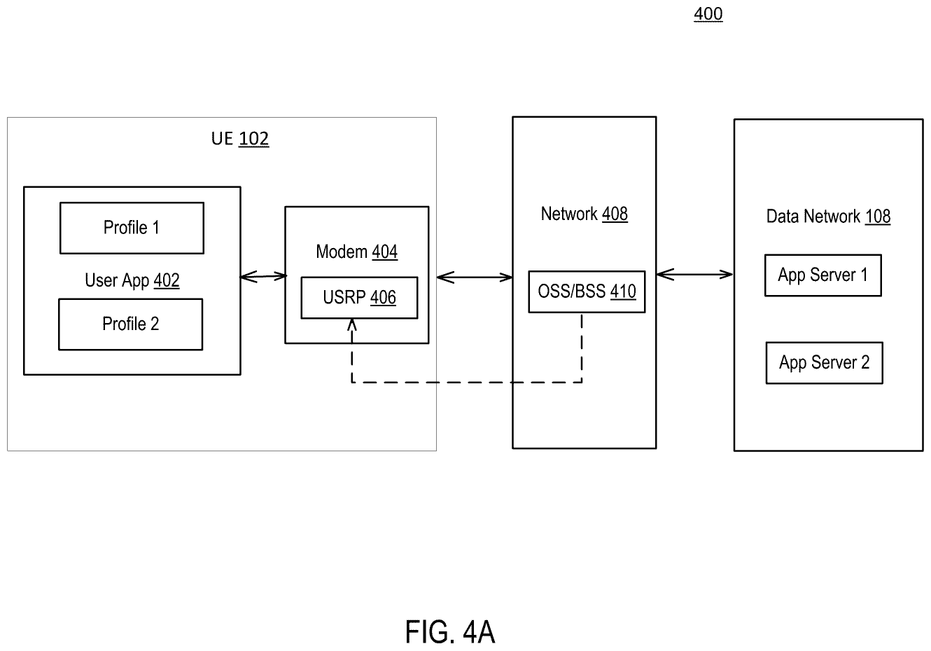

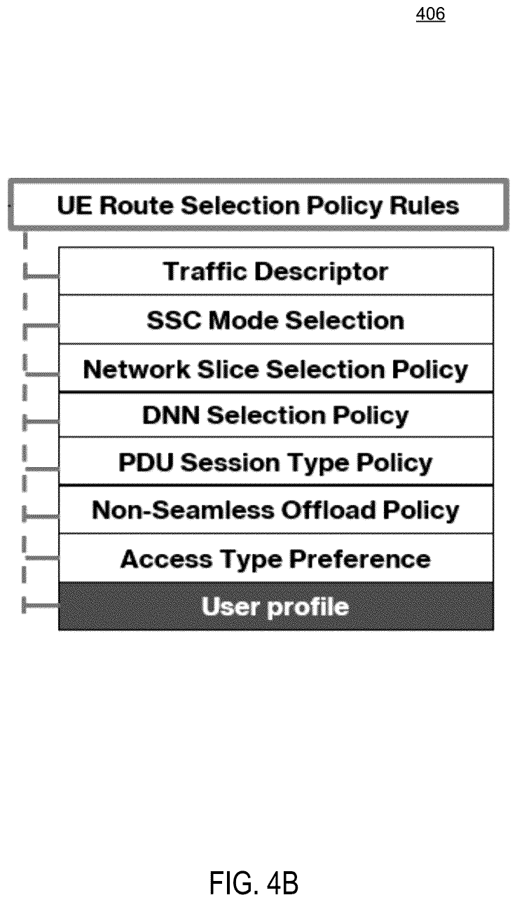

As discussed herein, the disclosed framework provides a novel universal software radio peripheral (USRP) table (or USRP, used interchangeably) that provides functionality for a mapping at the user profile level of an application. As discussed in more detail below, as depicted in FIG. 4B, the improved USRP table functioning on a device can include an additional data field (or structure/table) that can include user profile information for differing user profiles of a user per application. Therefore, depending upon the specific user profile being used by a user for an application instance, the disclosed framework can designate specific network slices to the type of computing being performed via the specific user profile.

As such, according to some embodiments, as discussed herein, the disclosed framework can operate to separate application (or device) traffic based on the type of operations being performed therein/thereon, which can provide curated operating environments that improve security while enabling more efficient computing in line with the types of activities being performed via the application/device.

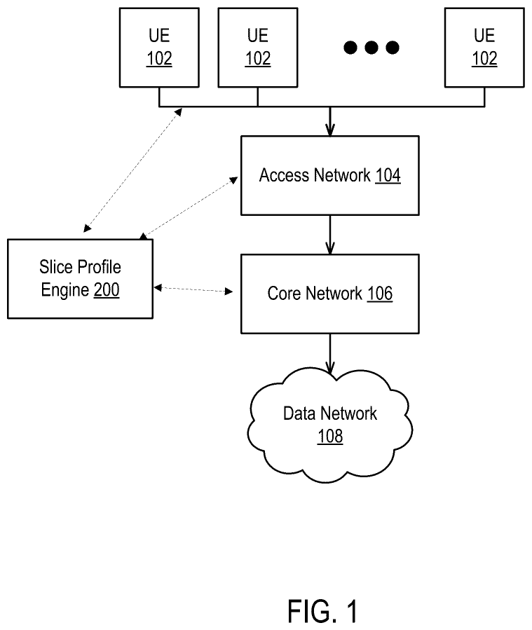

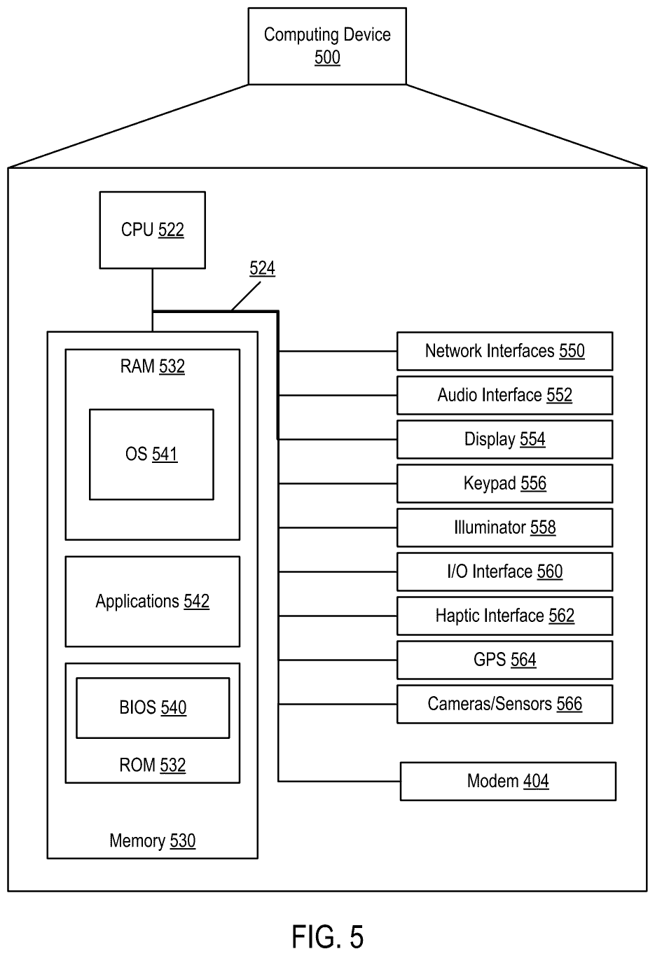

FIG. 1 is a block diagram of an example network architecture according to some embodiments of the present disclosure. In the illustrated embodiment, UE 102 accesses a data network 108 via an access network 104 and a core network 106. In the illustrated embodiment, UE 102 comprises any computing device capable of communicating with the access network 104. As examples, UE 102 may include mobile phones, tablets, laptops, sensors, Internet of Things (IoT) devices, autonomous machines, wired devices, wireless handsets, and any other devices equipped with a cellular or wireless or wired transceiver. One example of a UE is provided in FIG. 5.

In the illustrated embodiment, the access network 104 comprises a network allowing network communication with UE 102. In general, the access network 104 includes at least one base station that is communicatively coupled to the core network 106 and coupled to zero or more UE 102.

In some embodiments, the access network 104 comprises a cellular access network, for example, a 5G network. In an embodiment, the access network 104 can include a NextGen Radio Access Network (NG-RAN). In an embodiment, the access network 104 includes a plurality of next Generation Node B (e.g., eNodeB and gNodeB) base stations connected to UE 102 via an air interface. In one embodiment, the air interface comprises a New Radio (NR) air interface. For example, in a 5G network, individual user devices can be communicatively coupled via an X2 interface.

In the illustrated embodiment, the access network 104 provides access to a core network 106 to the UE 102. In the illustrated embodiment, the core network may be owned and/or operated by a network operator (NO) and provides wireless connectivity to UE 102. In the illustrated embodiment, this connectivity may comprise voice and data services.

At a high-level, the core network 106 may include a user plane and a control plane. In one embodiment, the control plane comprises network elements and communications interfaces to allow for the management of user connections and sessions. By contrast, the user plane may comprise network elements and communications interfaces to transmit user data from UE 102 to elements of the core network 106 and to external network-attached elements in a data network 108 such as the Internet.

In the illustrated embodiment, the access network 104 and the core network 106 are operated by a NO. However, in some embodiments, the networks (104, 106) may be operated by a private entity and may be closed to public traffic. For example, the components of the network 106 may be provided as a single device, and the access network 104 may comprise a small form-factor base station. In these embodiments, the operator of the device can simulate a cellular network, and UE 102 can connect to this network similar to connecting to a national or regional network.

In some embodiments, the access network 104, core network 106 and data network 108 can be configured as a multi-access edge computing (MEC) network, where MEC or edge nodes are embodied as each UE 102 and are situated at the edge of a cellular network, for example, in a cellular base station or equivalent location. In general, the MEC or edge nodes may comprise UEs that comprise any computing device capable of responding to network requests from another UE 102 (referred to generally for example as a client) and is not intended to be limited to a specific hardware or software configuration of a device.

FIG. 1 further includes slice profile engine 200 which is configured for performing network slice profile management. Slice profile engine 200 can be a special purpose machine or processor, and could be hosted by or integrated into functionality associated with UE 102. For example, as discussed below at least in relation to FIG. 4A, engine 200 can be integrated within modem 404 of UE 102. In some embodiments, the slice profile engine 200 can be hosted or provided by access network 104 or core network 106, or some combination thereof. For example, slice profile engine 200 can be configured to connect to, map to and/or integrate with eNodeB and gNodeB components (of access network 104) that connect core network 106 to UE 102. In another example, slice profile engine 200 can be hosted on a 5G Core—e.g., on network 106.

In some embodiments, engine 200 can be hosted by any type of network server, such as, but not limited to, an edge node or server, application server, content server, web server, and the like, or any combination thereof.

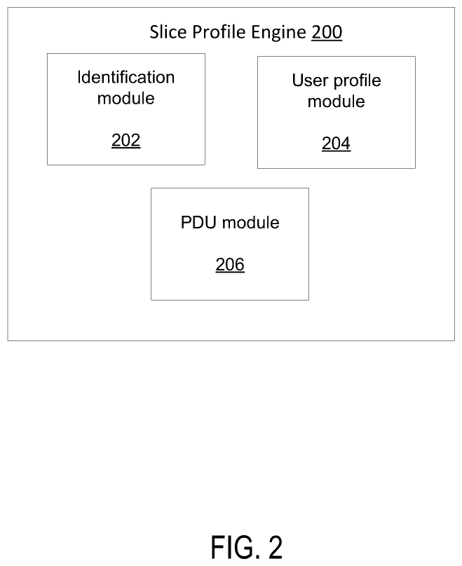

As depicted in FIG. 2, slice profile engine 200 can include, but is not limited to identification module 202, user profile module 204 and packet data unit (PDU) module 206.

In some embodiments, as discussed above, identification module 202 can operate to determine information related to a network session of a user, which can correspond to, but is not limited to, device information or identifier (ID), application information or ID, user profile ID, slice information, and the like, as discussed infra.

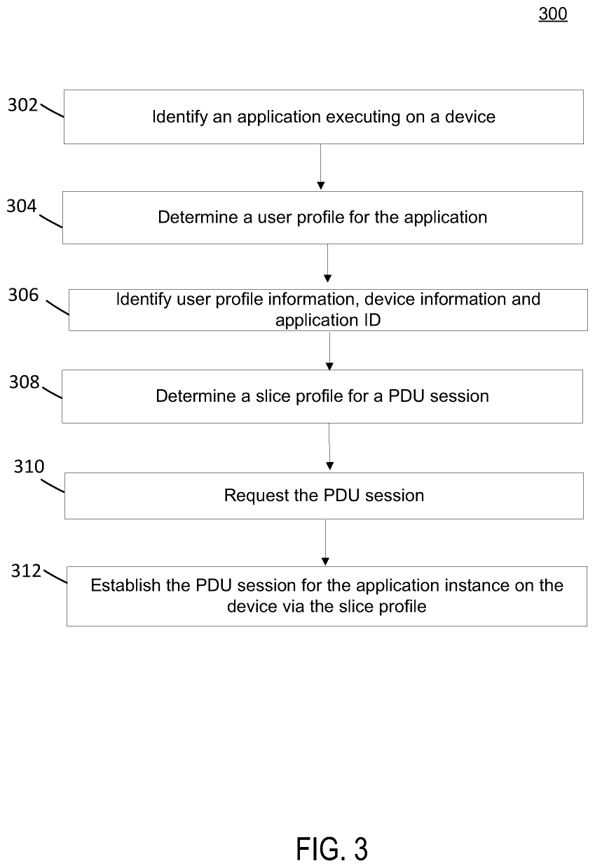

In some embodiments, user profile module 204 can function to select the proper slice profile for a user's network session. Further detail of operation of user profile module 204 will be discussed below in relation to FIGS. 3, 4A and 4B.

In some embodiments, PDU module 206 can function to generate and/or establish a PDU session with data network 108. Further detail of operation of PDU module 206 will be discussed below in relation to FIGS. 3 and 4A.

In some embodiments, slice profile engine 200 can be connected to a database or data store (not shown). The database can store information collected, processed and/or determined from the computations performed by each module 202-206. Such information can include data and metadata associated with local and/or network traffic information related to enterprises, users, profiles, UEs, services, applications, content and the like.

It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below in relation to FIGS. 3 and 4A-4B.

FIG. 3 depicts process 300 which details non-limiting example embodiments of the slice profile engine 200's implementation for management and implementation of a slice profile for PDU sessions.

According to some embodiments, Steps 302-306 of process 300 can be performed by identification module 202 of slice profile engine 200; Step 308 can be performed by user profile module 204; and Steps 310-312 can be performed by PDU module 206.

Process 300 begins with Step 302 where engine 200 can identify an application executing on a device, as well as the device. In some embodiments, the identification of the application can correspond to, but is not limited to, an application currently being interacted with on a device, an application being launched, an application being downloaded, an application being accessed or interacted with (or generating network traffic, for example), information related to the device upon which the application is executing (e.g., device identifiers and/or user information related to the device) and the like. In some embodiments, the application can be locally hosted and executed, and in some embodiments, the application can be a web-based application.

In some embodiments, the application can have a set of user profiles associated therewith. For example, a user can have a set of types of profiles for the application, which can be any type and/or number of profiles—for example, social profiles, work profiles, personal profiles, family profiles, and the like. For example, a user can have a work user profile for a BlueJeans application on their device (e.g. username: user@work.com), and a personal account as well (e.g., username: user@personal.com). As discussed in more detail below, upon the creation of such profiles, the information related to such profiles (or accounts) can be stored in the USRP table (as discussed in relation to FIG. 4B, infra).

In Step 304, engine 200 can determine the user profile (e.g., current user profile or account) logged into the account. In some embodiments, this can involve tracking the login credentials input by the user, and/or identifying the user profile currently active in the application instance/session.

In Step 306, engine 200 can identify the user profile information, device information and application information (e.g., application ID). In some embodiments, Step 306 can involve identifying or extracting user profile information and application ID information from the application program interface (API) executing on the device. In some embodiments, the device information can provide information related to compatibility (e.g., device type and/or capabilities of the device), which can be utilized for slice selection and/or generation. For example, for VR meetings, if the UE is not supported, an additional headset may be required to be connected and/or identified. In some embodiment, the device information can provide information related to, but not limited to, International Mobile Equipment Identity (IMEI), model number, operating system (OS), primary usage, and the like.

In some embodiments, Step 306 can additionally involve identifying information related to the application session, which can include, but is not limited to, network activity parameters (e.g., type of network, network channel/port, service profile, bandwidth, latency, speed, security, and the like), user parameters (e.g., types of activity of the user via the application), policy parameters (as discussed below in relation to FIG. 4B), mode parameters (as discussed below in relation to FIG. 4B), session parameters (as discussed below in relation to FIG. 4B), location parameters, time parameters, and the like, or some combination thereof.

In Step 308, engine 200 can determine a slice profile for a PDU session for the application via the specific user profile. In some embodiments, Step 308 can involve engine 200 compiling the user profile information, device information and/or application ID (among the other information identified in Step 306, discussed supra) as an input (or query), and communicating the compiled information (within the device/UE) to an integrated circuit (IC) (e.g., modem or subscriber identity module (SIM)) on the device/UE, which is the location of the USRP table, as discussed below. Accordingly, the USRP table enables the IC to determine which slice profile/ID to leverage for a PDU session, as in Step 308.

Thus, in Step 308, upon receiving the determined user profile information and application ID (from Step 306), the USRP table can be mined to locate a specific slice profile/ID for the specific application session. For example, if the application session involves the user's work account, then a slice profile for an enterprise session can be identified from the USRP table, as discussed above and in more detail below.

In Step 310, a PDU session can be requested. The PDU session request can include information related to a specific type of PDU session, identity of a network slice, identity of a specific application server (or network resource), and include information related to and/or be based on the specific slice profile/ID (from Step 308). In some embodiments, as discussed below, such information can be provided and/or retrieved from a USRP table, which can enable communication with a data network.

And, in Step 312, the PDU session can be established for the application instance on the device via the identified, specific slice profile. Thus, network traffic for the PDU session can be routed via the network slice that corresponds to the specifically leveraged slice profile. Further discussion and operational functionality of the mechanisms for performing the steps of process 300 are discussed below in relation to FIGS. 4A-4B.

FIG. 4A depicts environment 400, which may include UE 102, network 408 and data network 108. In the illustrated non-limiting environment 400, UE 102 includes user application (“app”) 402, for which two (2) user profiles for a user exist (profile 1 and profile 2—for example, a personal profile and a business profile, respectively). UE 102 further includes modem 404, which houses the USRP 406. For purposes of this discussion, an IC of UE 102 will be referred to as modem 404; however, it should not be construed as limiting, as it can be any type of known or to be known SIM or eSIM, and the like.

As depicted in FIG. 4B, USRP 406 may include information and/or parameters that provide traffic steering rules for a UE (e.g., a user device—UE 102). As discussed herein, USRP 406 includes functionality that enables a UE 102 to determine how certain applications should be handled in the context of traffic routing to an appropriate network slice or dynamic network name (DNN, in 5G networks). In some embodiments, USRP 406 can be provisioned by network 408 via access and mobility management function (AMF) and/or policy control function (PCF) components (not shown).

In some embodiments, USRP 406 can include route selection policy rules for a PDU session, which can include parameters such as, but not limited to, traffic descriptors, session and service continuity support (SSC) mode selection, network slice selection policy, DNN selection policy. PDU session type policy, non-seamless offload policy, access type preference and user profile(s). Accordingly, each of these parameters can be utilized to establish a PDU session for a specific network slice profile, as provided via the user profile(s) parameter, as discussed herein.

Turning back to FIG. 4B, in some embodiments, network 408 can correspond to access network 104 and/or core network 16, as discussed above in relation to FIG. 1. Within network 408 is OSS/BSS 410, which correspond to operation support systems (OSS) and business support systems (BSS) components, respectively. For example, OSS can correspond to network operations for personal computing, while BSS can correspond to network operations for enterprise computing. Thus, as depicted in FIG. 4B, via the dashed line, OSS/BSS 410 can provide network slice profile/ID information for profile 1 and profile 2 via an over-the-air (OTA) update.

In some embodiments, data network 108 can include, be associated with and/or provide access to application servers: app server 1 and app server 2, for example.

Thus, according to some embodiments, process 300 can function as follows: as in Step 302, profile 1 on user app 402 can be logged in/active. Thus, in Steps 304-306, the information related to profile 1 and the user app 402 can be identified and compiled, and sent to modem 404. In Step 308, the profile and app information can be utilized (by modem 404) to identify or extract the network slice profile for profile 1 and app 402. As discussed above, the network slice profile (and/or slice ID) can be provided by component 410, for which since profile 1 is a personal account, the slice profile information can be based on OTA provided information from OSS/BSS 410.

Accordingly, in Steps 310-312, UE 102 can then leverage the network slice profile specific to profile 1 to establish PDU session with data network 108, specifically app server 1 (which, in this example, is the application server providing personal computing networking for UE 102 via the personal network slicing).

According to some embodiments, should the user switch to profile 2 on app 402, then the network slice profile for profile 2 can be identified, and a PDU session specific to a network slice profile associated with profile 2 (as identified from USRP table 406) can be established in a similar manner. In some embodiments, via the established PDU session for the slice profile with profile 2, a connection can be established with an application server, for example, app server 1; that is, since only the profile and slice mapping are changing, but not the application, the app server can remain the same.

Accordingly, the disclosed systems and methods can provide curated application and network experiences via specified network slices that can be based on the types of user profiles applications are leveraging for a particular application's PDU session.

FIG. 5 is a block diagram illustrating a computing device showing an example of a client or server device used in the various embodiments of the disclosure.

The computing device 500 may include more or fewer components than those shown in FIG. 5, depending on the deployment or usage of the device 500. For example, a server computing device, such as a rack-mounted server, may not include audio interfaces 552, displays 554, keypads 556, illuminators 558, haptic interfaces 562, GPS receivers 564, or cameras/sensors 566. Some devices may include additional components not shown, such as graphics processing unit (GPU) devices, cryptographic co-processors, artificial intelligence (AI) accelerators, or other peripheral devices.

As shown in FIG. 5, the device 500 includes a central processing unit (CPU) 522 in communication with a mass memory 530 via a bus 524. The computing device 500 also includes one or more network interfaces 550, an audio interface 552, a display 554, a keypad 556, an illuminator 558, an input/output interface 560, a haptic interface 562, an optional global positioning systems (GPS) receiver 564 and a camera(s) or other optical, thermal, or electromagnetic sensors 566. Device 500 can include one camera/sensor 566 or a plurality of cameras/sensors 566. The positioning of the camera(s)/sensor(s) 566 on the device 500 can change per device 500 model, per device 500 capabilities, and the like, or some combination thereof. The computing device 500 can also include modem 404, as discussed above at least in relation to FIG. 4A.

In some embodiments, the CPU 522 may comprise a general-purpose CPU. The CPU 522 may comprise a single-core or multiple-core CPU. The CPU 522 may comprise a system-on-a-chip (SoC) or a similar embedded system. In some embodiments, a GPU may be used in place of, or in combination with, a CPU 522. Mass memory 530 may comprise a dynamic random-access memory (DRAM) device, a static random-access memory device (SRAM), or a Flash (e.g., NAND Flash) memory device. In some embodiments, mass memory 530 may comprise a combination of such memory types. In one embodiment, the bus 524 may comprise a Peripheral Component Interconnect Express (PCIe) bus. In some embodiments, the bus 524 may comprise multiple busses instead of a single bus.

Mass memory 530 illustrates another example of computer storage media for the storage of information such as computer-readable instructions, data structures, program modules, or other data. Mass memory 530 stores a basic input/output system (“BIOS”) 540 for controlling the low-level operation of the computing device 500. The mass memory also stores an operating system 541 for controlling the operation of the computing device 500.

Applications 542 may include computer-executable instructions which, when executed by the computing device 500, perform any of the methods (or portions of the methods) described previously in the description of the preceding Figures. In some embodiments, the software or programs implementing the method embodiments can be read from a hard disk drive (not illustrated) and temporarily stored in RAM 532 by CPU 522. CPU 522 may then read the software or data from RAM 532, process them, and store them to RAM 532 again.

The computing device 500 may optionally communicate with a base station (not shown) or directly with another computing device. Network interface 550 is sometimes known as a transceiver, transceiving device, or network interface card (NIC).

The audio interface 552 produces and receives audio signals such as the sound of a human voice. For example, the audio interface 552 may be coupled to a speaker and microphone (not shown) to enable telecommunication with others or generate an audio acknowledgment for some action. Display 554 may be a liquid crystal display (LCD), gas plasma, light-emitting diode (LED), or any other type of display used with a computing device. Display 554 may also include a touch-sensitive screen arranged to receive input from an object such as a stylus or a digit from a human hand.

Keypad 556 may comprise any input device arranged to receive input from a user. Illuminator 558 may provide a status indication or provide light.

The computing device 500 also comprises an input/output interface 560 for communicating with external devices, using communication technologies, such as USB, infrared, Bluetooth™, or the like. The haptic interface 562 provides tactile feedback to a user of the client device.

The optional GPS transceiver 564 can determine the physical coordinates of the computing device 500 on the surface of the Earth, which typically outputs a location as latitude and longitude values. GPS transceiver 564 can also employ other geo-positioning mechanisms, including, but not limited to, triangulation, assisted GPS (AGPS), E-OTD, CI, SAI, ETA, BSS, or the like, to further determine the physical location of the computing device 500 on the surface of the Earth. In one embodiment, however, the computing device 500 may communicate through other components, providing other information that may be employed to determine a physical location of the device, including, for example, a MAC address, IP address, or the like.

The present disclosure has been described with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure has been described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure, a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

To the extent the aforementioned implementations collect, store, or employ personal information of individuals, groups, or other entities, it should be understood that such information shall be used in accordance with all applicable laws concerning the protection of personal information. Additionally, the collection, storage, and use of such information can be subject to the consent of the individual to such activity, for example, through well known “opt-in” or “opt-out” processes as can be appropriate for the situation and type of information. Storage and use of personal information can be in an appropriately secure manner reflective of the type of information, for example, through various access control, encryption, and anonymization techniques (for especially sensitive information).

In the preceding specification, various example embodiments have been described with reference to the accompanying drawings. However, it will be evident that various modifications and changes may be made thereto, and additional embodiments may be implemented without departing from the broader scope of the disclosed embodiments as set forth in the claims that follow. The specification and drawings are accordingly to be regarded in an illustrative rather than restrictive sense.

What is claimed is:

1. A method comprising:
identifying, by a device an application being executed in accordance with a first user profile associated with a user;
determining, by the device, information related to the first user profile and the application;
identifying, by the device, based on the determined information, a first slice profile for the first user profile, the first slice profile being identified from a universal software radio peripheral (USRP) table hosted by the device, the first slice profile comprising specified network slicing functionality corresponding to a type of the first user profile; and
establishing, by the device, via a network, a packet data unit (PDU) session for the application based on the first slice profile.

2. The method of claim 1, wherein the PDU session for the first slice profile corresponds to network traffic with a specific network resource that corresponds to the type of the first user profile.

3. The method of claim 1, further comprising:
determining a switch to a second user profile for the application;
identifying, from the USRP table, a second slice profile, the second slice profile comprising specified network slicing functionality corresponding to a type of the second user profile; and
establishing, over the network, another PDU session for the application based on the second slice profile, the other PDU session.

4. The method of claim 3, wherein the other PDU session for the second slice profile corresponds to network traffic with a specific network resource that corresponds to the type of the second user profile.

5. The method of claim 1, wherein the USRP comprises a profile data structure comprising parameters associated with each user profile of the application, wherein each parameter corresponds to a slice profile for each user profile.

6. The method of claim 5, wherein each slice profile is mapped to a respective user profile by one of an operation support systems (OSS) and business support systems (BSS) component on the network.

7. The method of claim 1, wherein the USRP is hosted by an integrated circuit on the device.

8. The method of claim 7, wherein the integrated circuit is one of a modem and subscriber identity module (SIM) component associated with the device.

9. The method of claim 1, wherein the application information comprises an application identifier (ID).

10. The method of claim 1, further comprising:
identifying device information related to the device, wherein the determination of the slice profile is further based on the device information.

11. A device comprising:
a processor configured to:
identify an application being executed in accordance with a first user profile associated with a user;
determine information related to the first user profile and the application;
identify, based on the determined information, a first slice profile for the first user profile, the first slice profile being identified from a universal software radio peripheral (USRP) table hosted by the device, the first slice profile comprising specified network slicing functionality corresponding to a type of the first user profile; and
establish, via a network, a packet data unit (PDU) session for the application based on the first slice profile.

12. The device of claim 11, wherein the PDU session for the first slice profile corresponds to network traffic with a specific network resource that corresponds to the type of the first user profile.

13. The device of claim 11, wherein the processor is further configured to:
determine a switch to a second user profile for the application;
identify, from the USRP table, a second slice profile, the second slice profile comprising specified network slicing functionality corresponding to a type of the second user profile; and
establish, over the network, another PDU session for the application based on the second slice profile, the other PDU session, wherein the other PDU session for the second slice profile corresponds to network traffic with a specific network resource that corresponds to the type of the second user profile.

14. The device of claim 11, wherein the USRP comprises a profile data structure comprising parameters associated with each user profile of the application, wherein each parameter corresponds to a slice profile for each user profile, wherein each slice profile is provided by one of an operation support systems (OSS) and business support systems (BSS) component on the network.

15. The device of claim 11, wherein the USRP is hosted by an integrated circuit on the device, wherein the integrated circuit is one of a modem and subscriber identity module (SIM) component associated with the device.

16. A non-transitory computer-readable medium tangibly encoded with instructions, that when executed by a processor, perform the following:
identifying, by the device, an application being executed in accordance with a first user profile associated with a user;
determining, by the device, information related to the first user profile and the application;
identifying, by the device, based on the determined information, a first slice profile for the first user profile, the first slice profile being identified from a universal software radio peripheral (USRP) table hosted by the device, the first slice profile comprising specified network slicing functionality corresponding to a type of the first user profile; and
establishing, by the device, via a network, a packet data unit (PDU) session for the application based on the first slice profile.

17. The non-transitory computer-readable medium of claim 16, wherein the PDU session for the first slice profile corresponds to network traffic with a specific network resource that corresponds to the type of the first user profile.

18. The non-transitory computer-readable medium of claim 16, wherein the processor further performs the following:
determining a switch to a second user profile for the application;
identifying, from the USRP table, a second slice profile, the second slice profile comprising specified network slicing functionality corresponding to a type of the second user profile; and
establishing, over the network, another PDU session for the application based on the second slice profile, the other PDU session, wherein the other PDU session for the second slice profile corresponds to network traffic with a specific network resource that corresponds to the type of the second user profile.

19. The non-transitory computer-readable medium of claim 16, wherein the USRP comprises a profile data structure comprising parameters associated with each user profile of the application, wherein each parameter corresponds to a slice profile for each user profile, wherein each slice profile is provided by one of an operation support systems (OSS) and business support systems (BSS) component on the network.

20. The non-transitory computer-readable medium of claim 16, wherein the USRP is hosted by an integrated circuit on the device, wherein the integrated circuit is one of a modem and subscriber identity module (SIM) component associated with the device.
